(19) United States
(12) Patent Application Publication
(10) Pub. No.: US 2003/0160082 A1
(43) Pub. Date: Aug. 28, 2003

(54) Bolt setting tool

(76) Inventors: Joachim Gunther, Kaufering (DE); Stefan Haslberger, Freising (DE); Joachim Keck, Eschen (DE); Guido Kramann, Leonberg (DE)

Correspondence Address: SIDLEY AUSTIN BROWN & WOOD LLP, 787 Seventh Avenue, New York, NY, 10019, US

(21) Appl. No.: 10/322,820

(22) Filed: Dec. 18, 2002

(30) Foreign Application Priority Data
Dec. 20, 2001 (DE) 101 62 633.9

(51) Int. Cl. B25C 1/14

(52) U.S. Cl. 227/10

(57) ABSTRACT

A bolt setting tool including a piston (2) for driving a fastening element (3) in a workpiece, a housing (6); a handle (5) projecting radially from a longitudinal axis (A) of the setting tool (1) a damping (4) provided between the housing (6) and the handle (5); and having its connection point (P) with the housing (6) located, with respect to the handle (5), behind an outer side of the housing (6) adjacent to the handle or adjacent to an outer side of the housing (6) remote from the handle (5).

### BACKGROUND OF THE INVENTION

1. Field of the Invention

The present invention relates to a bolt setting tool, e.g., a powder charge-operated setting tool, for driving fastening elements, such as bolts or nails, into a workpiece or a constructional component.

2. Description of the Prior Art

A bolt setting tool generally includes a housing and a handle that projects radially and is displaceable, relative to the housing, in a setting direction against a biasing force of a damping element to damp a recoil acting on the handle. A handgun-like handle a gripping point of which is located adjacent the center a gravity is suitable for a reliable guidance of the tool by a user. With a non-periodical, user-actuated setting process, each separate recoil pulse, which generates a transient force, generates a rotational pulse and, thus, turning of the setting tool out along the setting axis which has to be minimized.

European Publication EP-33 11 68A1 discloses a bolt setting tool that in order to prevent the recoil force from acting on the user, includes a guide housing for supporting the handle with a possibility of its axial displacement. The handle is displaced in the setting direction against a force of pneumatic damping means. Such mounting of a damped handle relative to the guide housing requires a relatively long displacement path that is available, however, to a very limited extent.

German Publication DE-41 34 581 A1 discloses a percussion power tool having two, projecting radially from the tool axis, handles which are pivotally supported on a respective outer side of the tool with intermediate viscoelastic damping means for an elastic pivotal movement along the tool axis. Pure pivotal movements of the handle result, particularly in the initial stage, in a not sufficiently high damping of transient forces.

German Patent DE-32 29 183 C2 discloses a percussion power tool having a handle which projects radially form the tool axis and which is supported by a hinge, which acts as a recoil dampener, for an adjustable elastic pivotal movement in a certain angular range. The pivot point of the handle is located on the adjacent outer side of the power tool.

German Publication DE-41 04 917 A1 discloses a setting tool a vibrating housing of which is connected with one or two, vibration damping, radially projecting handles which are supported on the housing by elastic and damping means. The tool further includes a hinge frame fixedly connected with the housing and which provides for translational displacement a pivotal movement of the handle or handles. The connection point of a handle is located on the adjacent outer side of the housing.

An object of the present invention is to provide a bolt setting tool with a projecting radially, from the tool axis, handle which would have a shorter damping path.

Another object of the present invention is to provide a bolt setting tool with a projecting radially, from the tool axis, handle, the turning out of which along the axis is prevented.

### SUMMARY OF THE INVENTION

These and other objects of the present invention, which will become apparent hereinafter, are achieved by providing a bolt setting tool including a piston for driving a fastening element in a workpiece, a housing, a handle projecting radially from a longitudinal axis of the setting tool, a damping element provided between the housing and the handle, and a hinge frame providing for translational and pivotal movement of the handle and having its connection point with the housing located, with respect to the handle, behind an outer side of the housing adjacent to the handle.

With the connection point of the hinge frame with the housing being located behind the outer side of the housing adjacent to the handle, the pivotal movement of the handle exceeds the translational movement of the handle in the same direction. This noticeably reduces, in particular within first three ms, the transmission of the transient forces from the handle to the guide hand of the user during a recoil.

Alternatively, the connection point of the hinge frame with the housing can be located behind the tool axis and, advantageously, adjacent to the outer side of the housing remote from the handle. In this case, with a gripping point of the handle, which lies approximately in the middle of the handle, being spaced from the connection point by a greater distance than it is spaced from the tool axis, a substantial damping of a transient force in the initial stage can be achieved along with only a small turning out of the setting tool.

Advantageously, the connection point has a small, oriented along the tool axis, degree of freedom which is achieved by arranging the connection point in an elongate opening of several mm.

Advantageously, the angular region of the pivotal movement of the handle lies in a range from 10° to 20° whereby, at an arm of 150 mm, the displacement of the gripping point from abut 30 mm to about 50 mm, which is induced by the pivotal movement, is obtained. In addition, advantageously, a translatory displacement from 1 mm to 4 mm is obtained by arranging the connection (pivot) point in a correspondingly elongated opening.

Advantageously, the damping means is formed as a viscoelastic body arranged between the hinge frame and the housing, whereby the hinge frame is supported, in its rest position, by elastic components provided on its opposite sides, and a deflection by the dissipative components of the viscoelastic material during heating disappears. A suitable material for the damping means is selected from a group of material including polyurethane (PUR), polyamide-6 (PA) and other similar material and all of which have good damping characteristic, good temperature resistance, high dynamic E-module, and high tear resistance.

Advantageously, dependent on the characteristics of the used viscoelastic material, the damping body is so geometrically dimensioned that it has for a linear torsional damping system, a stiffness of about 40 Nm/rad with a damping capacity of 0.5 Nms/rad and, for a linear elastic damping system, a stiffness of about 160 N/mm with damping of 2.0 Ns/mm.

The foregoing damping characteristics permit to achieve, in conventional setting tools with a mass of about 3.5 kg and an energy of 600 J, in comparison with an undamped handle, in the initial stage, a reduction in acceleration of the handle by about 30%.

Advantageously, the damping means is formed as a compact body with a prismatic, truncated wedge geometry, which excludes local increased tension or elongation which occur in concave recesses and, thereby, prevents tear even at high dynamic loads.

Alternatively, the hinge frame can have an angular shape, with the wing of the angular hinge frame being connected with the housing by damping means. This permits to achieve, with the same or comparative viscoelastic material, harder damping characteristics of the setting tool.

Advantageously, the hinge frame is formed of deflection-resistant, advantageously stiffened by impressions, sheet metal.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

In the Drawings:

FIG. 1 shows a side view of a bolt setting tool according to the present invention;

FIG. 2 shows a side view of another embodiment of a bolt setting tool according to the present invention;

FIG. 3 shows a rear view of the bolt setting tool shown in FIG. 2; and

FIG. 4 shows a side view of further embodiment of a bolt setting tool according to the present invention.

### DETAILED DESCRIPTION OF THE PREFERRED EMBODIMENT

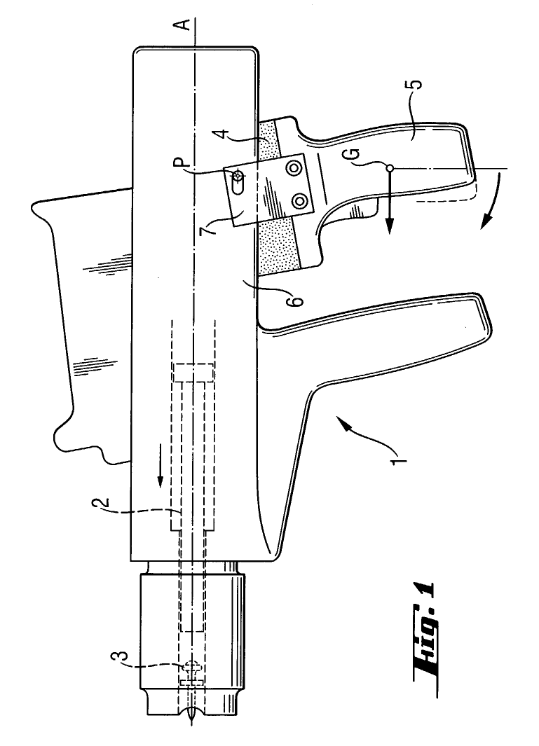

A bolt setting tool 1 according to the present invention, which is shown in FIG. 1, has a piston 2 for driving, e.g., a nail 3 in a workpiece or a constructional component, a handle 5 projecting radially from a longitudinal axis A of the tool 1 and separated from the tool housing 6 by damping means 4. A hinged frame 7, which is fixedly secured to the housing 6 at one of its end and is secured to the handle 5 at another of its end and is spaced radially by a distance of about 3 mm from the gripping point G, provides for translational movement of the handle 5 and for a pivotal movement of the handle 5 by about 15°, with a connection point P being displaceably and pivotally arranged in an elongate opening and located, with respect to he handle 5, behind an adjacent outer side of the housing 6. The damping means 4 is formed as a compact viscoelastic body having a prismatic, truncated wedge geometry.

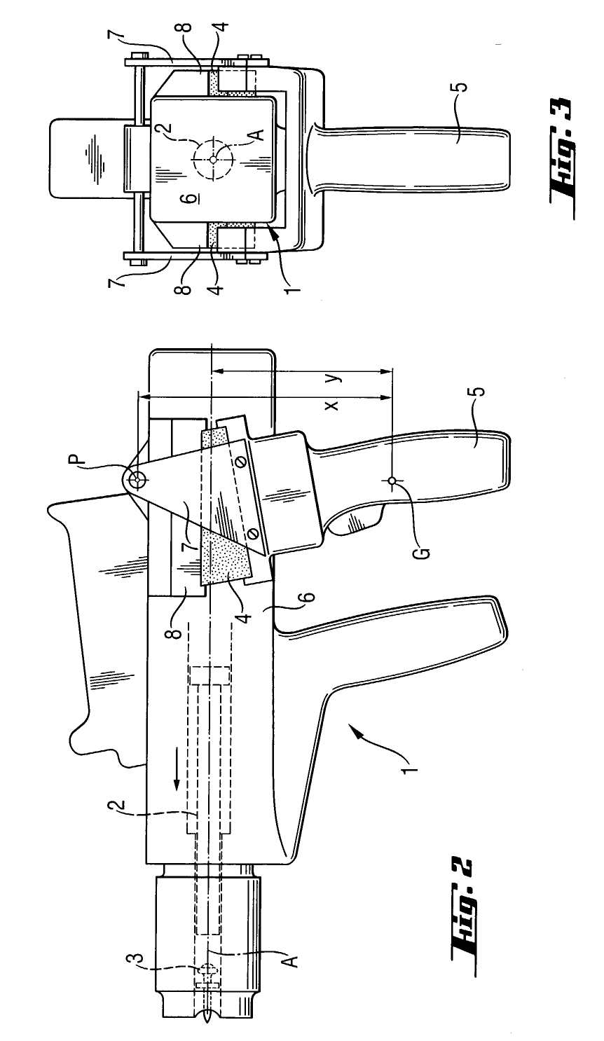

In the embodiment of a bolt setting tool 1 shown in FIG. 2, the connection point P is located above the longitudinal axis A of the tool 1 adjacent to the opposite, with respect to handle 5, outer side of the housing 6. With this location of the connection point P, the distance X from the connection point P to the gripping point G is greater than the distance Y between the axis A and the gripping point G.

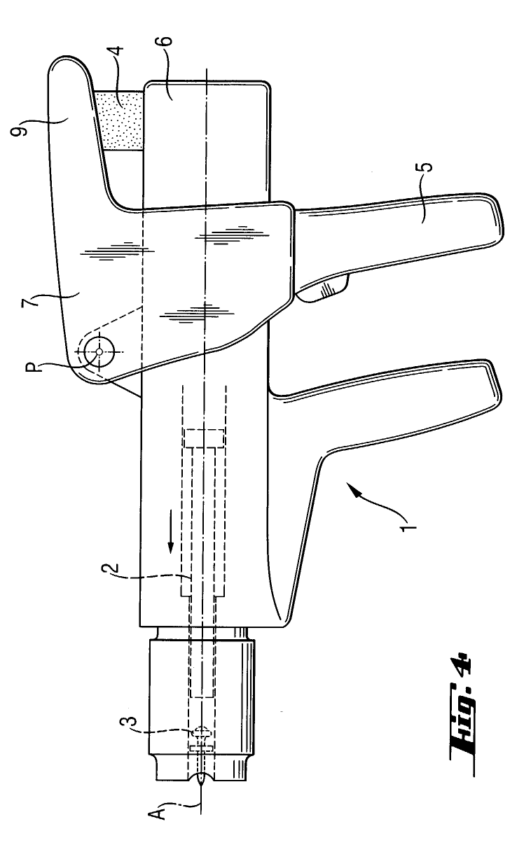

As shown in FIG. 3, the hinge frame 7 is formed of a deflection-resistant sheet metal and supports a fork-shaped handle 5 with damping means 4 provided on opposite sides of the handle 5 and extending up to a overhang 8 in the housing 6.

In the embodiment of a bolt setting tool 1 according to the present invention which is shown in FIG. 4, the hinge frame 7 has an angular shape with a wing 9, which is spaced from the connection point P, being connected with the housing 6 by damping means 4.

Though the present invention was shown and described with references to the preferred embodiment, such is merely illustrative of the present invention and are not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed:

1. A bolt setting tool, comprising a piston (2) for driving a fastening element (3) in a workpiece; a housing (6); a handle (5) projecting radially from a longitudinal axis (A) of the setting tool (1); a damping means (4) provided between the housing (6) and the handle (5); and having a connection point (P) thereof with the housing (6) located, with respect to the handle (5), behind an outer side of the housing (6) adjacent to the handle (5).

2. A bolt setting tool according to claim 1, wherein an angular region of the pivotal movement of the handle (5) lies in a range from 10° to 20°, and the translational movement of the gripping point (G) provided on the handle (5) lies in a range from 1 mm to 4 mm.

3. A bolt setting tool according to claim 1, wherein the damping means (4) comprises a viscoelastic body located between the hinge frame (7) and the housing (6).

4. A bolt setting tool according to claim 1, wherein the viscoelastic body is formed of one of polyurethane (PUR) elastomer and polyamide (PA).

5. A bolt setting tool according to claim 3, wherein the damping means (4) are so dimensioned, dependent on a used viscoelastic material, that it has, for a linear torsional damping system, a stiffness of about 40 Nm/rad with a damping capacity of 0.5 NMs/rad and, for a linear elastic damping system, a stiffness of about 160 N/mm with damping of 2.0 Ns/mm.

6. A bolt setting tool according to claim 3, wherein the viscoelastic body is formed, as a compact body having a prismatic, truncated wedge geometry.

7. A bolt setting tool according to claim 1, wherein the hinge frame (7) is formed of deflection-resistant sheet metal.

8. A bolt setting tool according to claim 7, wherein the hinge frame is formed of deflection-resistant sheet metal stiffened by impressions.

9. A bolt setting tool, comprising a piston (2) for driving a fastening element (3) in a workpiece; a housing (6); a handle (5) projecting radially from a longitudinal axis (A) of the setting tool (1); a damping means (4) provided between the housing (6) and the handle (5); and having a connection point (P) thereof with the housing (6) located, with respect to the handle (5) adjacent an outer side of the housing (6) remote from the handle (5).

10. A bolt setting tool according to claim 9, wherein an angular region of the pivotal movement of the handle (5) lies in a range from 10° to 20°, and the translational movement of the gripping point (G) provided on the handle (5) lies in a range from 1 mm to 4 mm.

11. A bolt setting tool according to claim 9, wherein the damping means (4) comprises a viscoelastic body located between the hinge frame (7) and the housing (6).

12. A bolt setting tool according to claim 9, wherein the viscoelastic body is formed of one of polyurethane (PUR) elastomer and polyamide (PA).

13. A bolt setting tool according to claim 12, wherein the damping means (4) are so dimensioned, dependent on a used viscoelastic material, that it has, for a linear torsional damping system, a stiffness of about 40 Nm/rad with a damping capacity of 0.5 NMs/rad and, for a linear elastic damping system, a stiffness of about 160 N/mm with damping of 2.0 Ns/mm.

14. A bolt setting tool according to claim 12, wherein the viscoelastic body is formed as a compact body having a prismatic, truncated wedge geometry.

15. A bolt setting tool according to claim 9, wherein the hinge frame (7) is formed of deflection-resistant sheet metal.

16. A bolt setting tool according to claim 15, wherein the hinge frame is formed of deflection-resistant sheet metal stiffened by impressions.

17. A bolt setting tool, comprising a piston (2) for driving a fastening element (3) in a workpiece; a housing (6); a handle (5) projecting radially from a longitudinal axis (A) of the setting tool (1); and an angular hinge frame (7) providing for translational and pivotal movement of the handle (5); and damping means (4) provided between a wing (9) of the angular hinge frame (7) and extending substantially parallel to the longitudinal axis (A) of the setting tool and the tool housing (6).
